(19) United States
(12) Patent Application Publication
(10) Pub. No.: US 2014/0208962 A1
(43) Pub. Date: Jul. 31, 2014

(54) Grilling Apparatus

(71) Applicant: Innovative International LLC, Lutz, FL (US)

(72) Inventor: Enoch Poon, Tampa, FL (US)

(21) Appl. No.: 14/047,455

(22) Filed: Oct. 7, 2013

Related U.S. Application Data
(63) Continuation-in-part of application No. 13/752,820, filed on Jan. 29, 2013.

(51) Int. Cl. A47J 37/06

(52) U.S. Cl. CPC A47J 37/06
USPC 99/445

(57) ABSTRACT

Disclosed is a grilling apparatus. The grilling apparatus is particularly configured to allow foods to be cooked over an open flame while minimizing flames and smoke. The flames and smoke are sufficiently reduced to permit the grill to be used indoors. The apparatus employs a grill and an underlying collection plate that cooperate in a manner that limits cooking fluids such as grease from dripping onto the open flame. It also suppresses flames generated by the fuel source. In one particular embodiment, the grill and collection plate are positioned over a stove.

### RELATED APPLICATION DATA

This application is a continuation-in-part of and claims priority to co-pending application Ser. No. 13/752,820 filed on Jan. 29, 2013 and entitled “Grilling Apparatus.” The contents of this application are fully incorporated herein for all purposes.

### TECHNICAL FIELD

This disclosure relates to a grilling apparatus. More specifically, this disclosure relates to a grilling apparatus that allows food to be cooked over an open flame while minimizing smoke and suppressing flames.

### BACKGROUND OF THE INVENTION

Barbeque grilling is a popular cooking method around the world. Barbeque grilling involves the direct heating of food from an underlying heat source, such as an open flame. The cooking surface is usually a metal grate or grill. The two most widely used grills are charcoal-fueled and gas-fueled. Conventional grilling tends to produce large amounts of smoke as grease and other cooking fluids come into contact with the heat source. These cooking fluids can also cause the flames to flare up and extend above the cooking surface. Various efforts have been made over the years to reduce the smoke and lessen flare ups associated with grilling.

For example, U.S. Pat. No. 6,701,829 to Farrow discloses a rapid anti-flare-up smoker for grills. The cooking device has two plates with apertures. The plates are adapted to be placed together with a gap formed therebetween. Wood chips can be placed in the smoker and the smoker can be placed directly upon a grill. The device allows fire to rise up to the cooking surface and also to catch grease dripping from the meat.

U.S. Pat. No. 6,520,174 to Scigliuolo discloses a two stage fire control cooking apparatus. The apparatus includes a collection plate and a cooking plate. The collection plate has a curved lip that deflects gases being released by the heat source back to the heat source to prevent flames.

Another example is illustrated in U.S. Pat. No. 6,622,616 to Measom. Measom discloses a poultry roaster for use on top of a gas-fired cooker. A heat deflector is included that employs a circular plate for supporting a basting adapter. Holes in the bottom of the device are upwardly punched to form respective upwardly tapered annular grease dams around lower heat distribution holes to prevent grease from falling into the fire.

U.S. Pat. No. 5,735,260 to Rimback discloses a tile for use with a cooking grill. A plurality of frustro-conical bosses extend upwardly from the top surface. Each boss has a channel extending substantially vertically through the tile to the bottom surface. The channels and bosses are shaped to allow drippings to flow through the tile such that a portion of the drippings are vaporized.

Finally, U.S. Pat. No. 4,037,580 to Angelo discloses a meat cooking apparatus. The apparatus includes a container with a closable lid and a fire grate in the bottom. A circular baffle plate is included. The baffle plate includes holes to allow smoke rising from the meat to impinge directly on the meat.

Although each of the foregoing inventions achieves its own individual objective, all suffer from common drawbacks. For example, none of the background art discloses a device that controls the smoke and flames to such an extent that the grilling can be done indoors. The cooking apparatus of the present disclosure is aimed at fulfilling these and other objectives.

### SUMMARY OF THE INVENTION

One possible advantage of the present disclosure is achieved by providing a grilling apparatus that controls smoke and flames to an extent that the apparatus can be used indoors.

A further benefit is realized by providing a grilling apparatus with an apertured collection plate wherein the apertures can be configured to control the smoke and flames created while cooking.

Still yet another advantage is attained by providing a grilling apparatus that includes a grill and a collection plate that cooperate in such a manner as to greatly reduce the volume of fluids that come into contact with the heat source or flame.

The present disclosure realizes yet another advantage by including slots on the lower surface of a collection plate, whereby the flames coming into contact with the food can be controlled.

A further possible advantage is achieved by providing a grilling apparatus wherein the collection plate comprises channels configured to direct fluids toward the periphery of the collection plate.

Various embodiments of the invention may have none, some, or all of these advantages. Other technical advantages of the present invention will be readily apparent to one skilled in the art.

### BRIEF DESCRIPTION OF THE DRAWINGS

For a more complete understanding of the present disclosure and its advantages, reference is now made to the following descriptions, taken in conjunction with the accompanying drawings, in which:

FIG. 1 is a partially exploded view of the collection plate and grill surface of an embodiment of the present disclosure.

FIG. 2 is a top plan view of an embodiment of the collection plate.

FIG. 3 is a cross sectional view of an embodiment of the collection plate of the present disclosure as taken from line 3-3 of FIG. 2.

FIG. 4 is a perspective view of another embodiment of the collection plate of the present disclosure.

FIG. 5 is a top plan view of another embodiment of the collection plate.

FIG. 6 is a cross sectional view of another embodiment of the collection plate of the present disclosure as taken from line 6-6 of FIG. 5.

FIG. 7 is a cross sectional view of another embodiment of the collection plate of the present disclosure positioned over a stove as taken from line 7-7 of FIG. 5.

10 Grilling Apparatus
12 Stove
14 Bottom Surface of Stove
16 Upper Peripheral Edge of Stove
18 Fuel Source
22 Collection Plate
24 Flanged Peripheral Edge of Collection Plate
26 Convex Bottom Surface of Collection Plate
28 Space Between Stove and Collection Plate
32 Ledge
34 Plurality of Collection Channels
36 First Raised Peripheral Edge of Channel
37 Second Raised Peripheral Edge of Channel
38 Trough in Bottom of Collection Plate
40 Slots in Bottom of Collection Plate
42 Grill
44 Distance Between Grill and Collection Plate
46 Grill Elements

### DETAILED DESCRIPTION OF THE DRAWINGS

The present disclosure relates to grilling apparatus that is particularly configured to allow foods to be cooked over an open flame while minimizing flames and smoke. The grilling apparatus is particularly configured to be used indoors. The apparatus employs a grill and an underlying collection plate that cooperate in a manner that contains cooking fluids and suppresses flames. In one particular embodiment, the grill and collection plate are positioned over a charcoal burning stove. The various components of the present invention, and the manner in which they can relate, are described in greater detail hereafter.

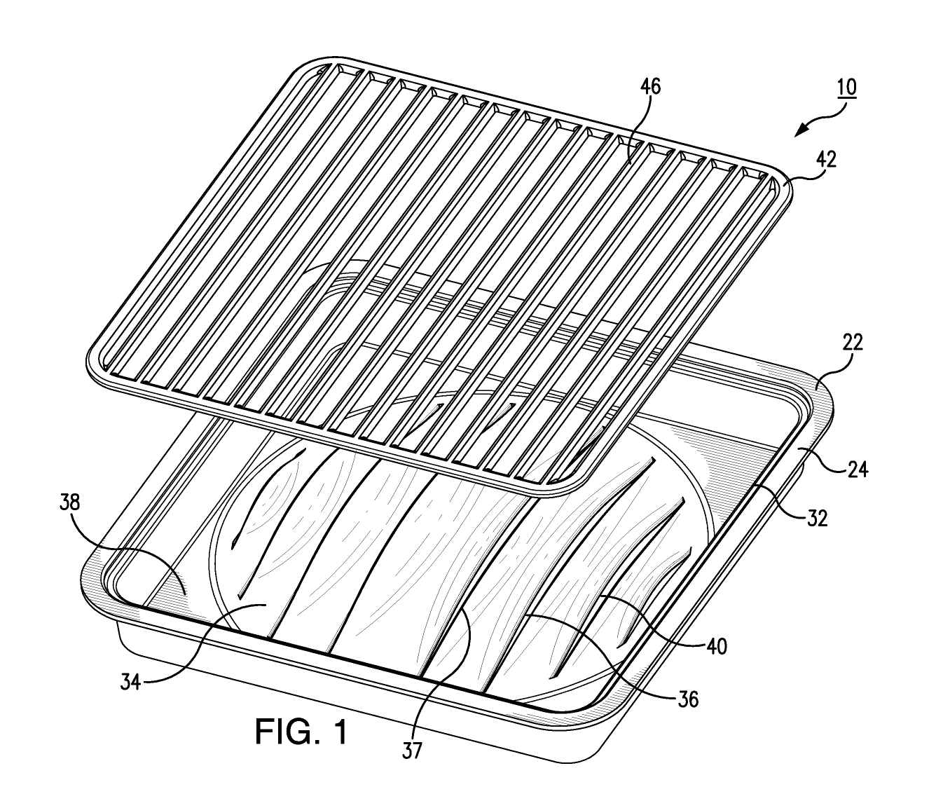

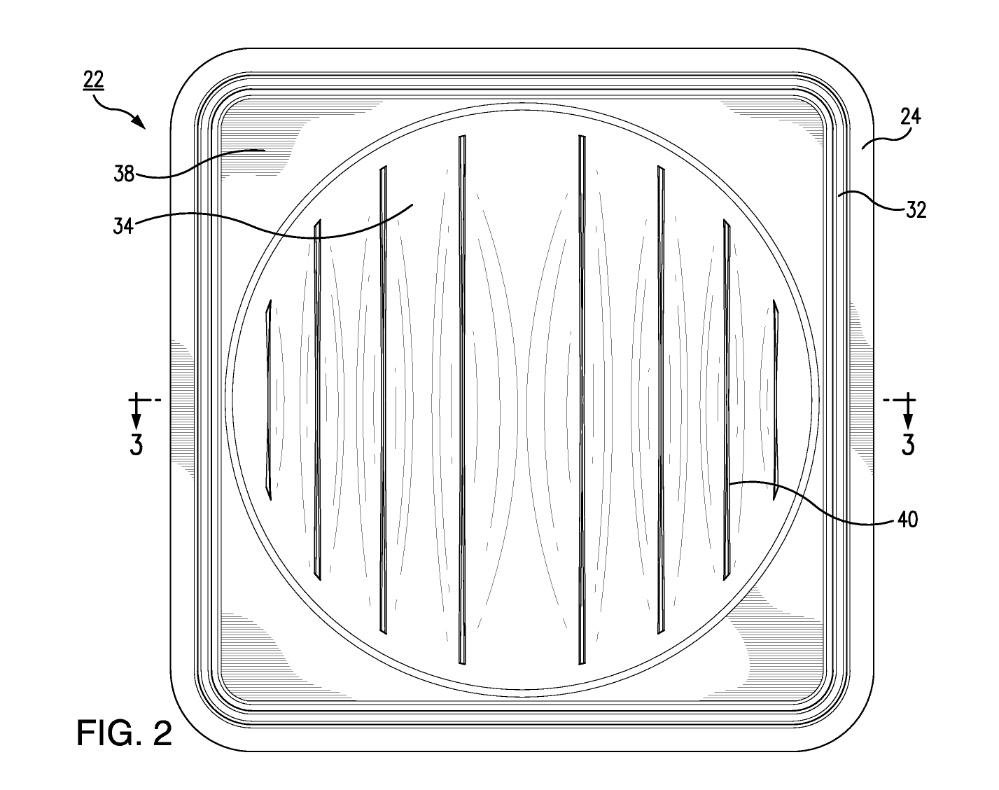

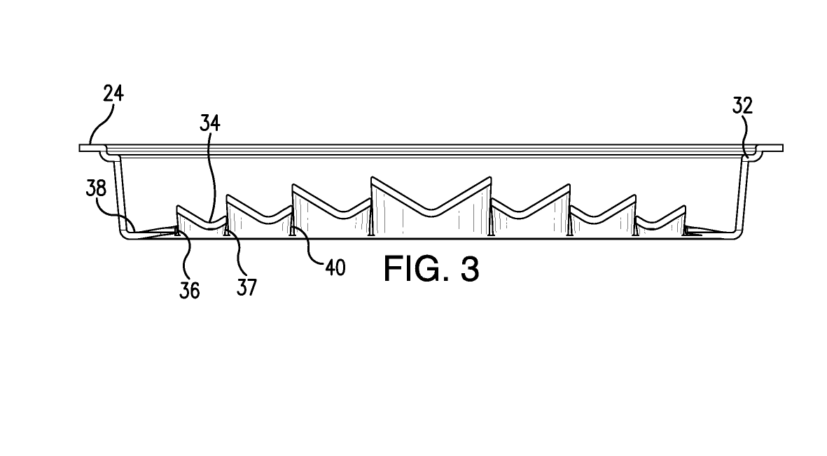

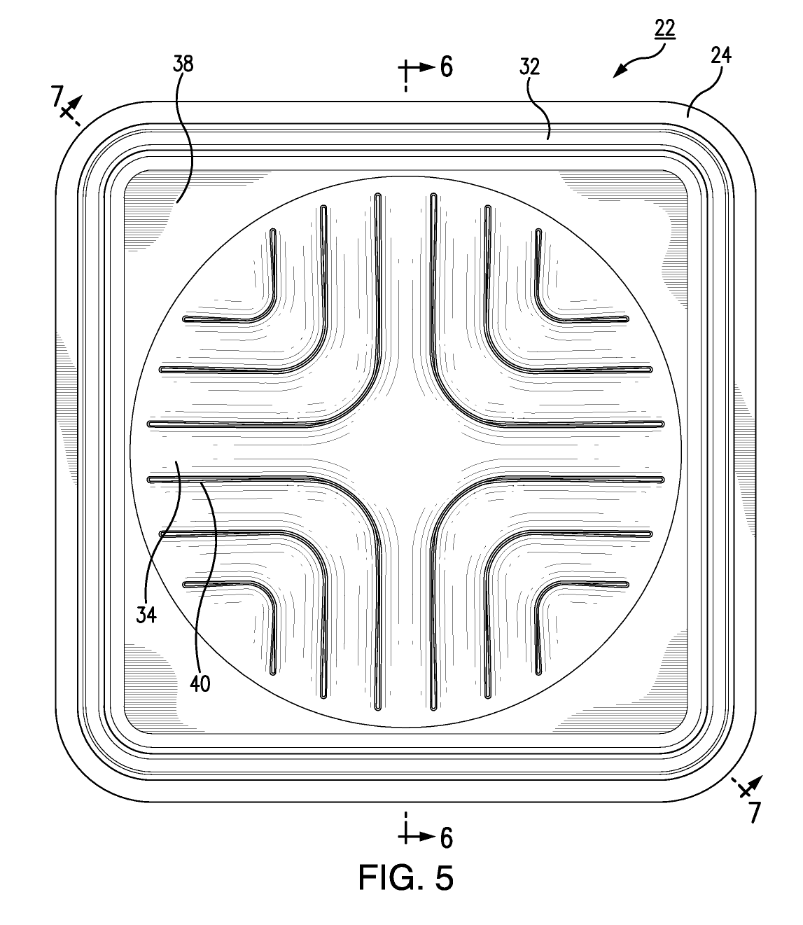

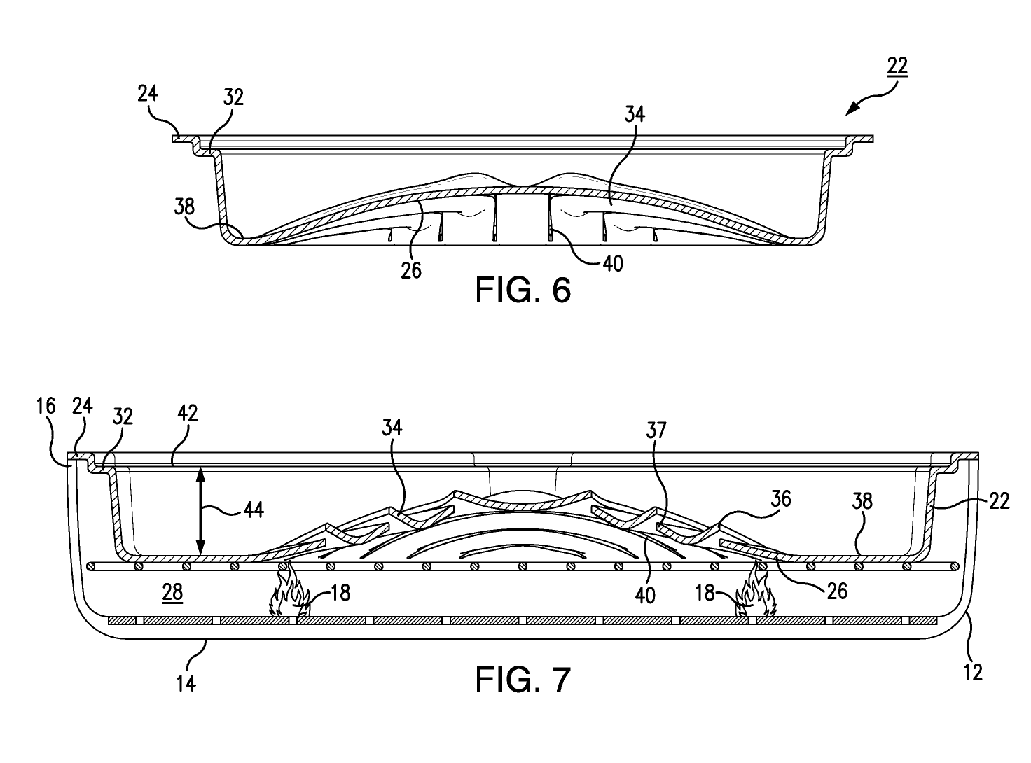

As noted in FIGS. 1-7, the apparatus 10 includes a collection plate 22 and a grill 42. In one particular, but non-limiting example, the collection plate 22 and grill 42 are positioned over top of a stove 12 containing an open flame (FIG. 7). Stove 12 can be of a conventional construction. In the depicted embodiment, stove 12 includes a bottom surface 14 and an upper peripheral edge 16. Bottom surface 14 is ideally used to support a fuel source 18, such as charcoal. It is also possible for apparatus 10 to employ a fuel source other than charcoal, such as propane. Indirect heating can also be used. The upper peripheral edge 16 of stove 12 is used in supporting the grill and collection plate as explained hereinafter.

In accordance with the present disclosure the collection plate 22 is designed to be positioned over the top of stove 12. To facilitate this, collection plate 22 includes a flanged peripheral outer edge 24 that is dimensioned to fit over the peripheral edge 16 of stove 12. However, this is not the only suitable arrangement. Namely, it is also envisioned that the bottom 26 of the collection plate 22 can sit directly upon the top of grill 42. This arrangement avoids the need for the dimensions of edges 16 and 24 to match. It also allows the apparatus 10 to be used with a wider range of conventional grills.

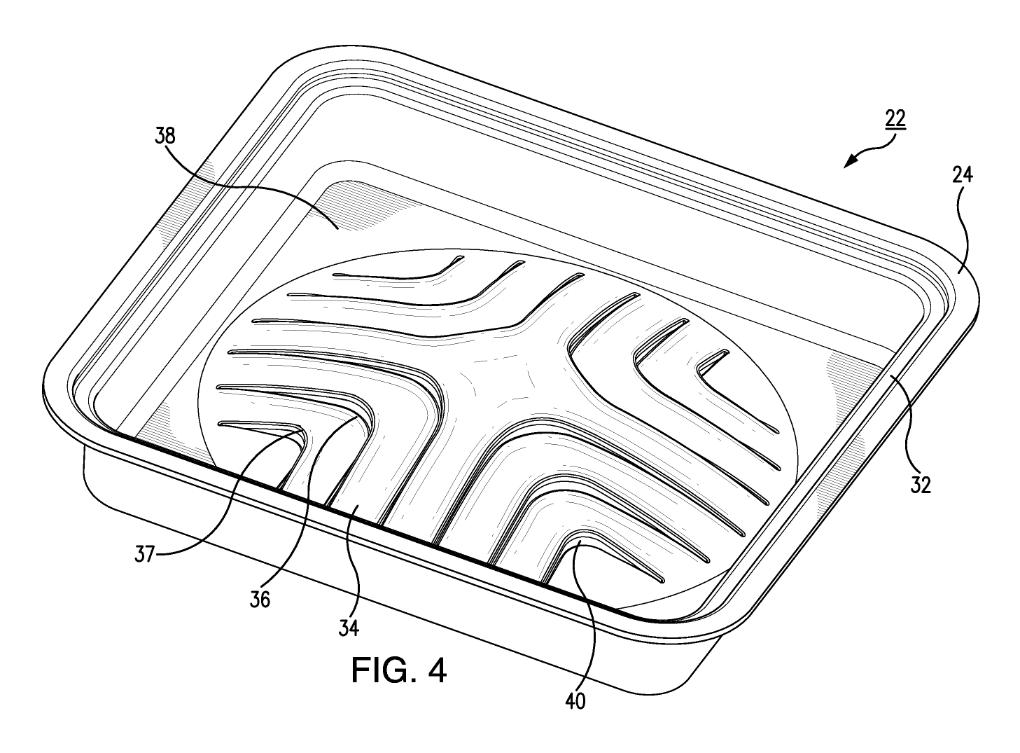

Collection plate 22 preferably includes inwardly angled side walls that terminate at bottom surface 26. In the preferred embodiment, bottom surface 26 has a convex, rounded, or arcuate profile. The bottom surface further comprises a plurality of collection channels 34, the collection channels including a first and second raised peripheral edge 36, 37. Slots 40 are present along the convex bottom surface 26 of the collection plate 22, and may be positioned between the plurality of collection channels 34. In one embodiment, slots 40 and collection channels 34 are straight and parallel to one another (FIGS. 1-3). In another embodiment, slots 40 and collection channels 34 are angled (FIGS. 4-7). In particular, slots 40 and collection channels 34 are formed at approximately 90 degree angles and each extends radially outward from the apex, or center, of the convex bottom surface 26 of the collection plate 22. As illustrated in FIGS. 4-7, portions of the slots 40 and collection channels 34 are parallel. In either embodiment, adjacent collection channels 34 can be positioned in an overlapping or imbricated orientation. In this case, slots 40 would be formed between the adjacent upper and lower channels 34.

In use, collection plate 22 is positioned over top of stove 12, whereby a space 28 is created between the bottom surface 26 of collection plate 22 and the lower surface 14 of stove 12. A ledge 32 is formed adjacent to the peripheral edge 24 of the collection plate 22. The ledge 32 has uniform depth, the function of which is described in greater detail hereinafter. A trough 38 is formed within a peripheral edge of the convex bottom surface 26. In use, cooking fluids (i.e. grease, juices, or sauces) that drip down below grill 42 contact bottom surface 26. Additionally, the curvature of surface 26 routes the fluids into trough 38. Fluids collected in trough 38 can be disposed of after the cooking is completed.

The third component of apparatus 10 is the cooking surface or grill 42. Grill 42 overlies collection plate 22 to create a space 44 between the two components. Grill 42 is preferably formed from a plurality of spaced parallel grill elements 46 and is adapted to be received by the ledge 32. In one embodiment, the distance 44 between the grill 42 and the trough 38 in the bottom of the collection plate 22 is between ¼ and ¾ of an inch. However, the use of other arrangements and cooking surfaces can be utilized.

Grill 42 and collection plate 22 can be formed from any of a variety of metal casting processes, with sand casting being the preferred technique. In the depicted embodiment, grill 42 and plate 22 components are quadrilateral. However, circular shaped components can also be used if preferred. Non-stick coatings can be applied to the upper surface of grill 42. Grill 42 and collection plate 22 are preferably formed from a metal that is dish washer safe, such as cast iron, stainless steel, or porcelain-coated cast iron.

In use, user first puts the fuel source 18 within the bottom 14 of stove 12. Fuel source 18 is then ignited. Collection plate 22 is thereafter positioned over top of stove 12. In the depicted embodiment, this is accomplished by resting the peripheral flange 24 of collection plate 22 upon peripheral edge 16 of stove 12. Otherwise, the bottom 26 of collection plate 22 may simply rest on stove 12. In either arrangement, cooking surface or grill 42 is next positioned over collection plate 22 by resting on ledge 32. A pair of tongs (not shown) can be used to lift and position grill 42. Food is thereafter cooked on surface 42. As the cooking progresses, fluids from the food (i.e. grease, juices, sauces, etc.) will drip below grill 42 and onto the collection plate 22. Some of the fluids will be routed via collection channels 34. Some of the fluids will be routed via the convex bottom surface 26. In either event, the fluids are prevented from entering slots 40 via raised edges 36, 37 and are ultimately directed into peripheral trough 38 for later disposal. This arrangement greatly limits, if not eliminates, the smoke created by cooking fluids coming into contact with the open flames.

Although this disclosure has been described in terms of certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure.

What is claimed is:

1. An indoor cooking apparatus (10) that permits food to be cooked over an open flame while minimizing smoke and flames, the cooking apparatus comprising:
a stove (12) for containing the open flame, the stove (12) including a bottom surface (14) and an upper peripheral edge (16), a fuel source (18) positioned within the stove (12);
a collection plate (22) having a flanged peripheral edge (24) and a convex bottom surface (26), the flanged peripheral edge (24) secured to the upper peripheral edge (16) of the stove (12) such that a space (28) is created between the bottom surface (14) of the stove (12) and the convex bottom surface (26) of the collection plate (22), a ledge (32) formed adjacent to the flanged peripheral edge (24) of the collection plate (22), the ledge (32) having uniform depth, a plurality of collection channels (34) formed within the convex bottom surface (26), each of the plurality of collection channels (34) including a first and second raised peripheral edge (36, 37), a plurality of slots (40) formed within the convex bottom surface (26), the plurality of slots (40) positioned between the plurality of collection channels (34), a trough (38) formed within a peripheral edge of the convex bottom surface (26);
a grill (42) positioned at a distance (44) above the collection plate (22), the grill (42) formed from a plurality of spaced grill elements (46), the grill (42) adapted to be received within the ledge (32) of the collection plate (22).

2. A cooking apparatus (10) comprising:
a cooking flame;
a collection plate (22) with a peripheral edge (24) and a bottom surface (26), the bottom surface (26) positioned over the cooking flame, a plurality of slots (40) formed within a bottom surface (26);
a grill (42) secured into the peripheral edge (24) of the collection plate (22), the grill (42) formed from a plurality of spaced grill elements (46).

3. The apparatus as described in claim 2 wherein the cooking flame is created within a stove (12) with an upper peripheral edge (16), and wherein the peripheral edge (24) of collection plate (22) is mounted to the peripheral edge (16) of the stove (12).

4. The apparatus as described in claim 2 further comprising:
a ledge (32) formed within the peripheral edge (24) of the collection plate (22), with the ledge (32) having uniform depth, the grill (42) adapted to be received by the ledge (32) of the collection plate (22).

5. The apparatus as described in claim 2 further comprising a series of collection channels (34) formed within the bottom surface (26) of the collection plate (22).

6. The apparatus as described in claim 5, wherein the collection channels (34) further comprise a first and second raised peripheral edge (36, 37).

7. The apparatus described in claim 5, wherein the collection channels (34) are parallel.

8. The apparatus as described in claim 5, wherein the collection channels (34) extend radially outward from a center of the bottom surface (26) of the collection plate (22), and wherein portions of the collection channels (34) are parallel.

9. The apparatus as described in claim 2 further comprising a fluid trough (38) formed within an outside periphery of the collection plate (22).
